(19) United States
(12) Patent Application Publication
(10) Pub. No.: US 2025/0092776 A1
(43) Pub. Date: Mar. 20, 2025

(54) Beamforming Through Tubing For Cement Bond Evaluation And Borehole Mapping

(71) Applicant: Halliburton Energy Services, Inc., Houston, TX (US)

(72) Inventors: Frederico Heloui de Araujo, Rio de Janeiro (BR); Brenno Caetano Troca Cabella, Rio de Janeiro (BR); Ruijia Wang, Singapore (SG); Yao Ge, Singapore (SG); Otto Fanini, Houston, TX (US)

(73) Assignee: Halliburton Energy Services, Inc., Houston, TX (US)

(21) Appl. No.: 18/370,121

(22) Filed: Sep. 19, 2023

(51) Int. Cl. E21B 47/005; E21B 47/13

(52) U.S. Cl. CPC E21B 47/005; E21B 47/13

(57) ABSTRACT

A method for identifying a cement bond. The method may include disposing an acoustic logging tool into a tubing of a wellbore, wherein the wellbore further comprises casing cemented to a formation by a cement. The method may further include transmitting an acoustic signal into at least part of the tubing and at least part of the casing, measuring one or more signal waves from the at least part of the tubing and the at least part of the casing, and computing an array waveform from the one or more signal waves. Additionally, the method may include applying a beamforming algorithm to the array waveform to form a filtered signal, identifying eccentricity of the tubing within the casing using the filtered signal, and identifying a cement bond between the cement and the casing.

### BACKGROUND

Boreholes drilled into subterranean formations may enable recovery of desirable fluids (e.g., hydrocarbons) using any number of different techniques. During and after drilling operations, tubing, such as casing, is placed into the borehole to form a wellbore. To form the wellbore, the tubing is cemented to the subterranean formation. Cementing tubing to the subterranean formation is performed by pumping cement into the annulus between the tubing and rock of the subterranean formation. In other examples, cement may be pumped between two casings. The cement process allows for wellbore completion to keep formation integrity. For cementing quality control, quantitative measurements may be taken of the bonding condition at the interfaces between casing and cement. Cement bonding logging (CBL) may be utilized to determine well integrity, to ensure zonal isolation in a wellbore.

CBL via acoustic logging is essential to ensure the borehole condition. To save resources, it is desirable to perform the logging with the tool inside the tubing. The presence of these additional layers drastically reduces the amount of energy that arrives at the cement zone and is reflects back to inside the tubing. This may lead to incomplete and/or skewed measurements. Further, the presence of the tubing makes it impractical to centralize the tool in the casing. If the logging is not centered, measurements may be further skewed as acoustic pulses utilized in logging travel different distances depending on where the logging tool is in the tubing.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool;

FIG. 2 illustrates schematic drawing of the acoustic logging tool;

FIG. 3 illustrates an example information handling system;

FIG. 4 illustrates another example information handling system;

FIG. 5 illustrates a workflow for specular reflection beamforming;

FIG. 6 are graphs showing delay-and-sum beamforming;

FIG. 7 illustrates a third interface echo ray tracing measurement operation;

FIGS. 8A and 8B are a downhole view of an eccentered acoustic logging tool in a wellbore;

FIG. 9 is a graph formed form a ray-tracing model;

FIGS. 10A and 10B are graphs showing acoustic signatures of bonding conditions;

FIG. 11 is a workflow for guided wave beamforming;

FIG. 12 is another example of a delay-and-sum beamforming;

FIG. 13 illustrates a guided wave ray tracing operation; and

FIGS. 14A and 14B are graphs showing acoustic signatures of bonding conditions.

### DETAILED DESCRIPTION

Methods and systems herein may generally relate to beamforming techniques that are used to enhance the signal reflected in the casing making it possible to evaluate the cement bond condition and to map the tool's position inside the casing. The biggest challenge with this approach is how to calculate the delays applied in the beamforming, due to the eccentered tubing condition.

Using a linear array of receivers and a directional transmitter emitting acoustic energy towards the borehole wall, it is possible to apply the beamforming technique to isolate any specific acoustic mode propagating between the transmitter and the receiver array. When selecting the acoustic modes that interacts with the casing wall and goes back inside the borehole, the information obtained may be used to evaluate the cement bond condition behind the casing and the relative distance between the casing wall and the logging tool. The delays applied on the beamforming may be calculated using a ray-tracing model which makes it possible to identify all sound paths between the transmitter and the receiver.

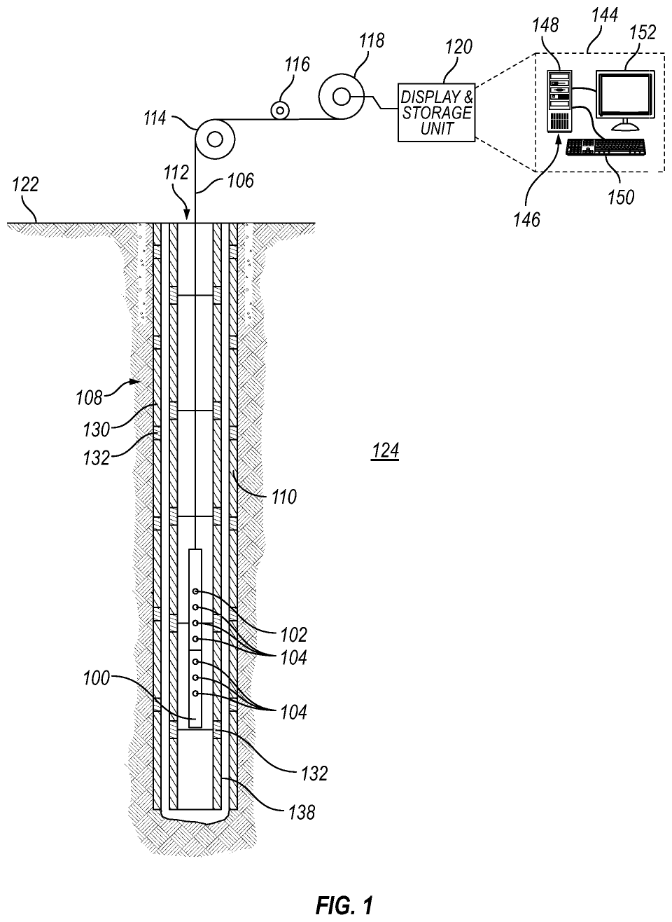

FIG. 1 illustrates an operating environment for an acoustic logging tool 100 as disclosed herein. Acoustic logging tool 100 may comprise a transmitter 102 and/or a receiver 104. Additionally, transmitter 102 and receiver 104 may be configured to rotate in acoustic logging tool 100. In examples, there may be any number of transmitters 102 and/or any number of receivers 104, which may be disponed on acoustic logging tool 100. Additionally, transmitter 102 and receiver 104 may be configured to rotate in acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within casing 108 to a desired depth within the wellbore 110. In examples, tubing may be concentric in the casing, however in other examples the tubing may not be concentric Conveyance 106, which may include one or more electrical conductors, may exit wellhead 112, may pass around pulley 114, may engage odometer 116, and may be reeled onto winch 118, which may be employed to raise and lower the tool assembly in the wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and stored for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical casing 108 may extend from wellhead 112 at or above ground level to a selected depth within a wellbore 110. Casing 108 may comprise a plurality of joints 130 or segments of casing 108, each joint 130 being connected to the adjacent segments by a collar 132. Additionally, casing 108 may be cemented to formation 124. Specifically, cement may be disposed between casing and formation 124 to hold casing 108 in place.

FIG. 1 also illustrates tubing 138, which may be positioned inside of casing 108 extending part of the distance down wellbore 110. Tubing 138 may be production tubing, tubing string, conduit string, or other pipe disposed within casing 108. Tubing 138 may comprise concentric pipes. It should be noted that concentric pipes may be connected by collars 132. Acoustic logging tool 100 may be dimensioned so that it may be lowered into the wellbore 110 through tubing 138, thus avoiding the difficulty and expense associated with pulling tubing 138 out of wellbore 110. Herein casing 108 may be comprised of tubing 138.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to surface 122 during logging (corrosion detection).

Acoustic logging tool 100 may be used for excitation of transmitter 102. As illustrated, one or more receivers 104 may be positioned on the acoustic logging tool 100 at selected distances (e.g., axial spacing) away from transmitter 102. The axial spacing of receiver 104 from transmitter 102 may vary, for example, from about 0 inches (0 cm) to about 40 inches (101.6 cm) or more. In some embodiments, at least one receiver 104 may be placed near the transmitter 102 (e.g., within at least 1 inch (2.5 cm) while one or more additional receivers may be spaced from 1 foot (30.5 cm) to about 5 feet (152 cm) or more from the transmitter 102. It should be understood that the configuration of acoustic logging tool 100 shown on FIG. 1 is merely illustrative and other configurations of acoustic logging tool 100 may be used with the present techniques. In addition, acoustic logging tool 100 may include more than one transmitter 102 and more than one receiver 104. For example, an array of receivers 104 may be used. Transmitters 102 may include any suitable acoustic source for generating acoustic waves downhole, including, but not limited to, monopole and multipole sources (e.g., dipole, cross-dipole, quadrupole, hexapole, or higher order multi-pole transmitters). Additionally, one or more transmitters 102 (which may include segmented transmitters) may be combined to excite a mode corresponding to an irregular/arbitrary mode shape. Specific examples of suitable transmitters 102 may include, but are not limited to, piezoelectric elements, bender bars, or other transducers suitable for generating acoustic waves downhole. Receiver 104 may include any suitable acoustic receiver suitable for use downhole, including piezoelectric elements that may convert acoustic waves into an electric signal.

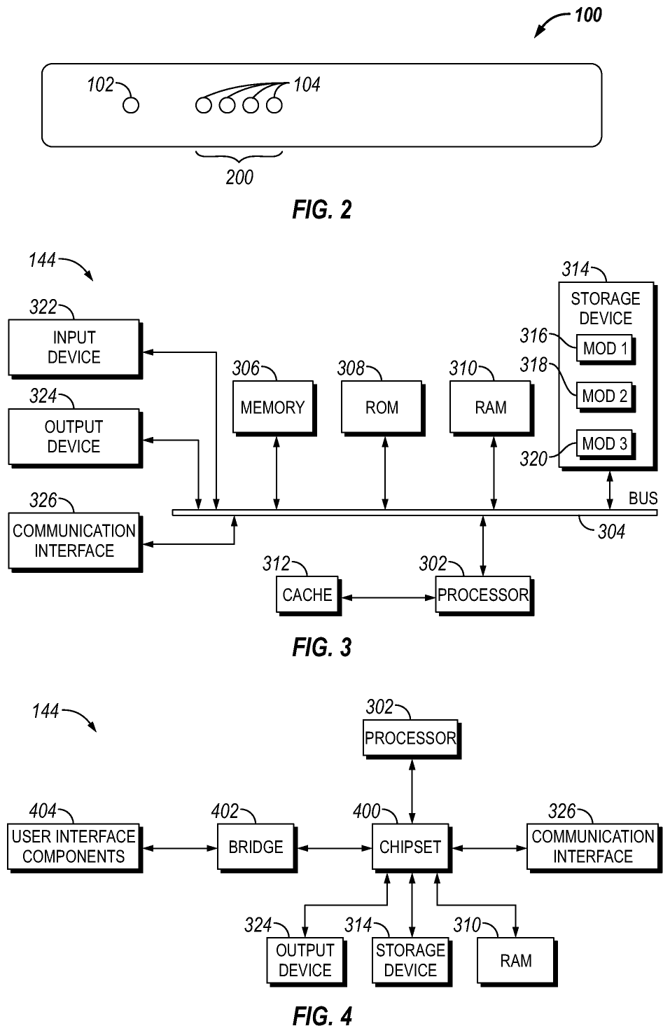

FIG. 2 illustrates a schematic layout of acoustic logging tool 100. As illustrated, acoustic logging tool 100 may comprise a transmitter 102 and an array 200 of receivers 104. In examples, transmitters 102 may be a directional transmitter and/or a unipole source. In other examples, transmitter 102 may be replaced by an array of transmitters 200 that may use beamforming techniques to create one or more focused acoustic beams. Receivers 104 may include a segmented piezoelectric tube, individual receiver, or azimuthal receiver array, which may produce azimuthal variation of bonding behind casing 108 (e.g., referring to FIG. 1). In examples, array 200 may be disposed above or below transmitter 102. Additionally, the spacing between each receiver 104 within array 200 may be the same or different. Further, receiver 104 may be positioned to create a non-linear array along the axis of acoustic logging tool 100. Generally, during operations, transmitter 102 may emit one or more acoustic waves with may interact with borehole structures, such as tubing, casing 108, borehole fluid, and/or acoustic logging tool 100 (e.g., referring to FIG. 1). The signal waves that have interacted with borehole structures may then be acquired by one or more receivers 104 within array 200.

Referring back to FIG. 1, transmission of acoustic waves by the transmitter 102 and the recordation of signals by receivers 104 may be controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). Non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

FIG. 3 illustrates an example information handling system 144 which may be employed to perform various steps, methods, and techniques disclosed herein. As illustrated, information handling system 144 includes a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 144 may include a cache 312 of high-speed memory connected directly with, in close proximity to, or integrated as part of processor 302. Information handling system 144 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may include multiple different types of memory with different performance characteristics. It may be appreciated that the disclosure may operate on information handling system 144 with more than one processor 302 or on a group or cluster of computing devices networked together to provide greater processing capability. Processor 302 may include any general purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may include multiple processors, such as a system having multiple, physically separate processors in different sockets, or a system having multiple processor cores on a single physical chip. Similarly, processor 302 may include multiple distributed processors located in multiple separate computing devices but working together such as via a communications network. Multiple processors or processor cores may share resources such as memory 306 or cache 312 or may operate using independent resources. Processor 302 may include one or more state machines, an application specific integrated circuit (ASIC), or a programmable gate array (PGA) including a field PGA (FPGA).

The information handling system 144 may comprise a processor 302 that executes one or more instructions for processing the one or more measurements. The information handling system 144 may comprise processor 302 that executes one or more instructions for processing the one or more measurements. Information handling system 144 may process one or more measurements according to any one or more algorithms, functions, or calculations discussed below. In one or more embodiments, the information handling system 144 may output a signal wave.

Processor 302 may include, for example a microprocessor, microcontroller, digital signal processor (DSP), application specific integrated circuit (ASIC), or any other digital or analog circuitry configured to interpret, execute program instructions, process data, or any combination thereof. Processor 302 may be configured to interpret and execute program instructions or other data retrieved and stored in any memory such as memory 306 or cache 312. Program instructions or other data may constitute portions of a software or application for carrying out one or more methods described herein. memory 306 or cache 312 may comprise read-only memory (ROM), random access memory (RAM), solid state memory, or disk-based memory. Each memory module may include any system, device or apparatus configured to retain program instructions, program data, or both for a period of time (e.g., computer-readable non-transitory media). For example, instructions from a software or application may be retrieved and stored in memory 306 for execution by processor 601.

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 144, such as during start-up. Information handling system 144 further includes storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may include software modules 316, 318, and 320 for controlling processor 302. Information handling system 144 may include other hardware or software modules. Storage device 314 is connected to the system bus 304 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 144 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 322 represents any number of input mechanisms, such as a microphone for speech, a touch-sensitive screen for gesture or graphical input, keyboard, mouse, motion input, speech and so forth. Additionally, input device 322 may take in data from one or more sensors 136, discussed above. An output device 324 may also be one or more of a number of output mechanisms known to those of skill in the art. In some instances, multimodal systems enable a user to provide multiple types of input to communicate with information handling system 144. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general-purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 144 may practice all or part of the recited methods, may be a part of the recited systems, and/or may operate according to instructions in the recited tangible computer-readable storage devices. Such logical operations may be implemented as modules configured to control processor 302 to perform particular functions according to the programming of software modules 316, 318, and 320.

In examples, one or more parts of the example information handling system 144, up to and including the entire information handling system 144, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may include one or more virtual machines, an overlay network, a hypervisor, virtual switching, and any other virtualization application.

FIG. 4 illustrates another example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may include, for example, magnetic media, and solid-state media. Chipset 400 may also read data from and write data to RAM 310. A bridge 402 for interfacing with a variety of user interface components 404 may be provided for interfacing with chipset 400. Such user interface components 404 may include a keyboard, a microphone, touch detection and processing circuitry, a pointing device, such as a mouse, and so on. In general, inputs to information handling system 144 may come from any of a variety of sources, machine generated and/or human generated.

Chipset 400 may also interface with one or more communication interfaces 326 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 302 analyzing data stored in storage device 314 or RAM 310. Further, information handling system 144 receives inputs from a user via user interface components 404 and executes appropriate functions, such as browsing functions by interpreting these inputs using processor 302.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. Using the systems and methods described above, acoustic logging tool 100 in conjunction with information handling system 144 may be utilized for well imaging. Well imaging may allow for the creation of a wellbore image that shows the location of casing 108 relative to acoustic logging tool 100. Further cement evaluation may also be undertaken to evaluate the cement bond condition between casing 108 and formation 124 (e.g., referring to FIG. 1). To perform well imaging and cement evaluation, beamforming methods and systems may be utilized.

Beamforming is a spatial filter for waves arriving from any direction of interest. This may be performed by a plurality of receivers 104 (e.g., referring to FIG. 2) that may take multiple spatial acquisition of a sound field. To apply the beamforming technique, it is necessary to choose an acoustic mode beforehand. For this disclosure, two forms of acoustics modes may be utilized, specular reflection beamforming and/or guided wave beamforming.

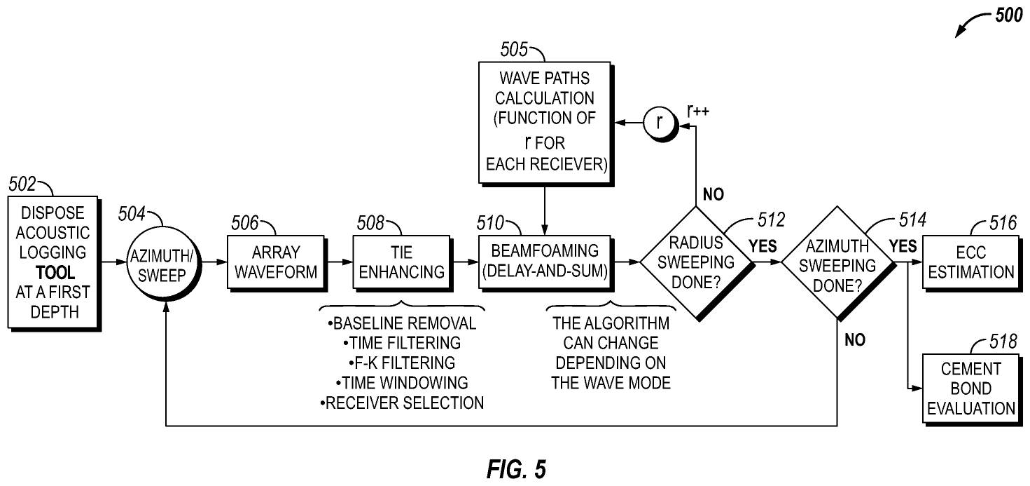

FIG. 5 illustrates workflow 500 for specular reflection beamforming. Workflow 500 may be performed at least in part utilizing acoustic logging tool 100 and/or information handling system 144 (e.g., referring to FIG. 1). As illustrated, workflow 500 may begin with block 502 in which acoustic logging tool 100 may be disposed within wellbore 110 (e.g., referring to FIG. 1) to any desired depth. After acoustic logging tool 100 has been disposed to the selected depth of wellbore 110 in block 502, in block 504 acoustic logging tool 100 may emit one or more acoustic pulses from transmitter 102 (e.g., referring to FIG. 1) in an azimuthal sweep of three hundred and sixty degrees at any depth toward casing 108. It should be noted that acoustic pulses may travel through casing 108 (e.g., referring to FIG. 1) before reaching casing 108. Acoustic logging tool 100, casing 108, tubing 138, and/or formation 124 may reflect, at least in part, one or more acoustic pulses. The reflected acoustic pulses may be referred to as signal waves. The signal waves may be sensed by one or more receivers 104.

In block 506, the sensed signal waves may be digitized, sent to, and/or stored on information handling system 144 as data according to the methods and systems described above. The signal waves may then be combined into an array waveform in block 506. The array waveform may be formed by acquiring simultaneously the acoustic signal for all receivers in the array. Once formed, the array waveform in block 506 may undergo processing actions, referred to herein as “actions,” within information handling system 144 to clean, filter, and amplify data within the array waveform. For this disclosure, “action” may be defined as the use of computational resources and power to perform mathematical algorithms, equations, and/or the like to qualify, clean, enhance, update, and/or the like to improve recorded data that may comprise noise and other extraneous information within a data set.

For example, in block 508, which may be optional, the array waveform may undergo third interface echo (TIE) enhancing actions within information handling system 144. TIE enhancing actions may comprise baseline removal, time filtering, F-K filtering, time windowing, receiver selection, and/or the like. Baseline removal may comprise subtracting the median of the signal waves acquired for all azimuths to be able to remove all “tubing modes” that are common for all directions. Time filtering may comprise eliminating the noise and any other unwanted frequency components. F-K filtering may comprise filtering the signal waves in the frequency-wavenumber domain to get rid of any other acoustic mode that is not of interest. Time windowing may comprise applying a time window to the signal wave received at each receiver 104 (e.g., referring to FIG. 2). The position and length of each time window is calculated taking into account the position of receiver 104 and the acoustic mode of interest. The action performed on the array waveform may create an enhanced data set for the array waveform to form an enhanced array waveform. As noted above, TIE enhancing action may not be utilized on the array waveform. Thus, the array waveform from block 506 or the enhanced array waveform from block 508 may be further refined utilizing a beamforming algorithm.

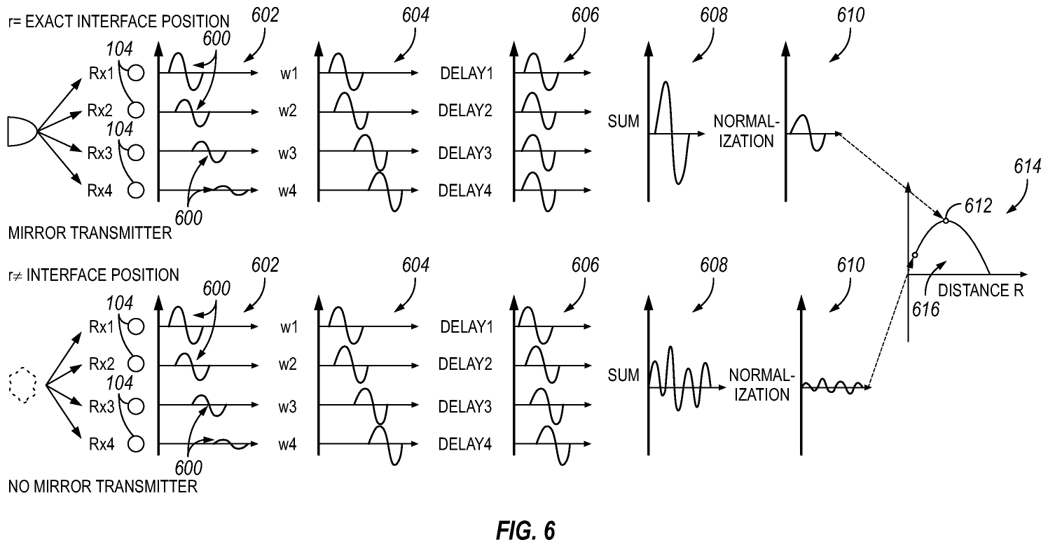

In block 510 a beamforming action may be performed on the array waveform form block 506 or the enhanced array waveform from block 508. The beamforming action may be an algorithm such as a delay-and-sum, Minimum Variance Distortionless Response (MVDR), Maximum Signal-to-Noise Ratio Filter, or any other algorithm. The operation of the delay-and-sum algorithm is illustrated in FIG. 6. In FIG. 6, one or more receivers 104 (e.g., referring to FIG. 1) sense and measure a signal wave 600. As illustrated in graphs 602, each of the one or more receivers 104 may measure and sense the same signal wave 600 differently. In block 505, a wave path calculation action may be performed where acoustic pulses and signal wave 600 may be mapped to identify the path both the acoustic pulses and signal waves may take during operation. This information may allow for the determine on why signal wave 600 is measured and sensed differently at each of the one or more receivers 104.

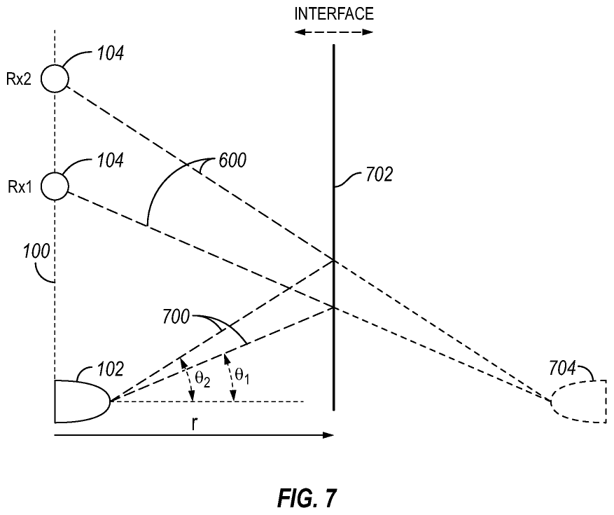

FIG. 7 illustrates a measurement operation utilizing acoustic logging tool 100. Specifically, a measurement operation using third interface echo ray tracing. It should be noted that the first interface is between fluid within tubing 138 (e.g., referring to FIG. 1) and internal wall of tubing 138. The second interface is the external wall of tubing 138 and fluid between casing 108 and tubing 138. The third interface is the fluid between tubing 138 and casing 108 and internal wall of casing 108. During measurement operations, acoustic logging tool 100 may emit an acoustic pulse 700 from transmitter 102. Acoustic pulse 700 may expand as it moves away from transmitter 102 toward interface 702. Further, acoustic pulse 700 may interact with interface 702, which may cause a signal wave 600 to originate from interface 702 and back toward each of the one or more receivers 104. As illustrated, each of the one or more receivers 104 may measure and sense signal wave 600 based at least in part on the angle of propagation, θ, of acoustic pulse 700 from transmitter 102. Thus, signal wave 600 may further be represented as if a mirror transmitter 704 is transmitting signal wave 600 from the opposite side of interface 702. The opposite side being the side of interface 702 that does not face transmitter 102. Mirror transmitter 704 may be utilized as a quality control to show the angle of signal wave 600 moving toward one or more receivers 104.

Referring back to FIG. 6, the position of interface 702 (e.g., referring to FIG. 7) may be moved ‘digitally’ by changing the argument r, which represents the distance between interface 702 and acoustic logging tool 100 (e.g., referring to FIG. 7). As illustrated in graphs 604 and 606, the amplitude and phase of signal wave 600 measured by each of the one or more receivers 104 are corrected as a function of the argument r. Then, each of the measured and sense signal waves 600 may be summed in graph 608 and normalized in graph 610. A peak value 612 in graph 614 of a filtered signal 616 or its Root Mean Square (RMS) value are the measured values at a first azimuth location for the argument r.

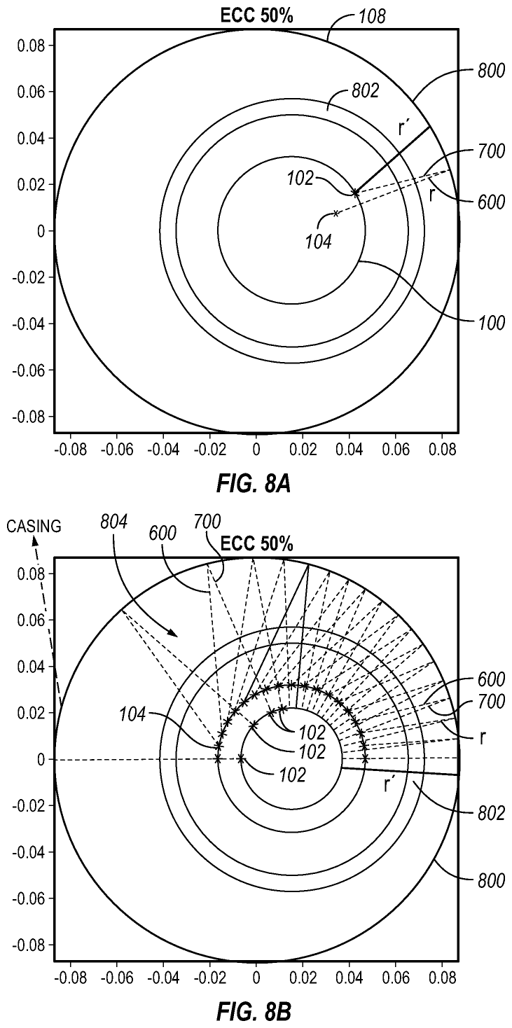

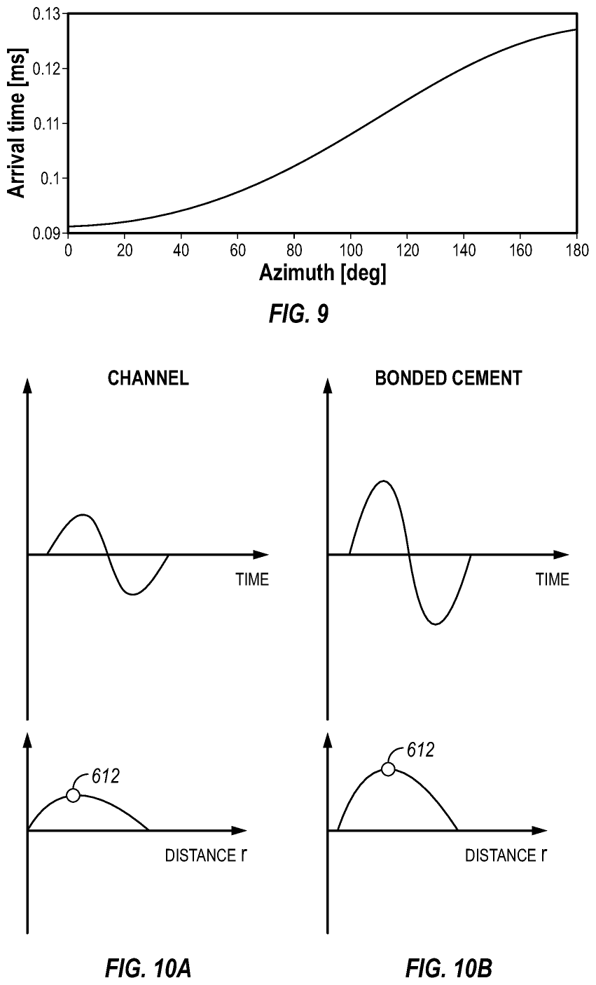

Referring back to FIG. 5, filtered signal 616, which is the output of block 510, may be stored for further processing in information handling system 144, using the methods and systems described above. After the argument r is swept in block 512, as acoustic logging tool 100 is rotated within wellbore 110 (e.g., referring to FIG. 1), and the proceeding is repeated for a new azimuth until acoustic logging tool 100 completes a 360 degrees rotation in block 514. FIG. 8A illustrates acoustic logging tool 100 disposed within eccentric tubing 802, where eccentric tubing 802 is disposed within casing 108. As illustrated in FIG. 8A, it should be noted that r is the distance traveled by acoustic pulse 700 and signal wave 600. Additionally, r′ is the distance from acoustic logging tool 100 to inner casing wall 800. Referring back to FIG. 5, after block 514, acoustic logging tool 100 may then be moved to the next depth and repeat the previous step. The measurements taken and found in workflow 500 may be utilized in an eccentering estimation action to determine eccentering in block 516 and a cement bond evaluation action in block 518. FIG. 8B illustrates that with eccentric tubing 802, the distance r calculated, will not be the same as the actual geometric distance between acoustic logging tool 100 and inner casing wall 800 (i.e., r′), due to the obliquus incidence of acoustic wave 700 at inner casing wall 800 that creates signal wave 600. As illustrated, ray path 804 may depend on where acoustic wave 700, originating from a transmitter 102, strikes inner casing wall 800 a signal wave 600 is received by one or more receivers 104. The r to r′ conversion is obtained using a ray-tracing model in FIG. 9. The conversion allows for r′ to be found from r.

Referring back to FIG. 5, in block 518 a cement bond evaluation may be performed. For the cement bond evaluation in block 518, the amplitude obtained when the argument r is equal to the distance traveled between acoustic logging tool 100 and inner casing wall 800 (e.g., referring to FIG. 8), for all azimuths and all measured depths may be compared. For example, as illustrated in FIG. 10A, peak value 612 for distance r indicates a channel may be located behind interface 702, which is inner casing wall 800. In FIG. 10B, peak value 612 for distance r indicates a full bond between cement and interface 702. Thus, a full three-hundred-and-sixty-degree image may be formed, showing the locations of bonding, channels, and/or partial bonding. Other workflows may be utilized to determine bonding conditions between cement and interface 702.

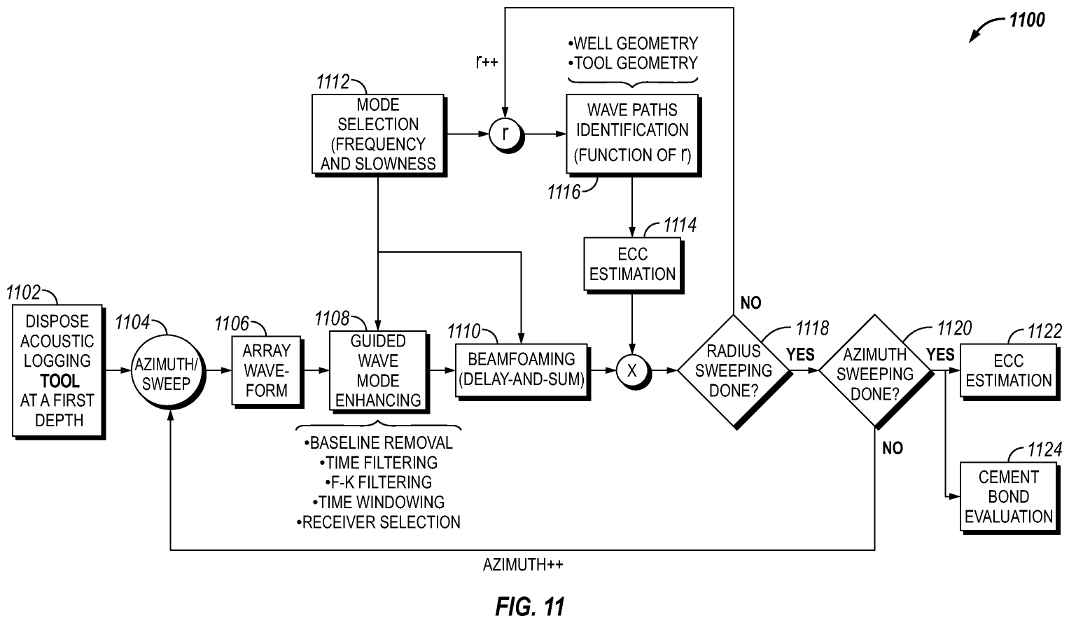

FIG. 11 illustrates a workflow 1100 for guided wave beamforming. Workflow 11 may be performed at least in part utilizing acoustic logging tool 100 and/or information handling system 144 (e.g., referring to FIG. 1). As illustrated, workflow 1100 may begin with block 1102 in which acoustic logging tool 100 may be disposed within wellbore 110 (e.g., referring to FIG. 1) to any desired depth. After acoustic logging tool 100 has been disposed to the selected depth of wellbore 110 in block 1102, in block 1104 acoustic logging tool 100 may emit one or more acoustic pulses from transmitter 102 (e.g., referring to FIG. 1) in an azimuthal sweep toward casing 108. It should be noted that acoustic pulses may travel through casing 108 (e.g., referring to FIG. 1) before reaching casing 108. Acoustic logging tool 100, casing 108, casing 108, and/or formation 124 may reflect, at least in part, one or more acoustic pulses. The reflected acoustic pulses may be referred to as signal waves 600 (e.g., referring to FIG. 6). Signal waves 600 may be sensed by one or more receivers 104.

In block 1106, the sensed signal waves may be digitized, sent to, and/or stored on information handling system 144 as data according to the methods and systems described above. Signal waves 600 may then be combined into an array waveform in block 1106. The array waveform may be formed by acquiring simultaneously the acoustic signal for all receivers in the array. Once formed, the array waveform in block 1106 may undergo processing actions, referred to herein as “actions,” within information handling system 144 to clean, filter, and amplify data within the array waveform. For this disclosure, “action” may be defined as the use of computational resources and power to perform mathematical algorithms, equations, and/or the like to qualify, clean, enhance, update, and/or the like to improve recorded data that may comprise noise and other extraneous information within a data set.

For example, in block 1108, which may be optional, the array waveform may undergo guided wave mode enhancing actions within information handling system 144. Guided wave mode enhancing may comprise baseline removal, time filtering, F-K filtering, time windowing, receiver selection, and/or the like. Baseline removal may comprise subtracting the median of the signal waves acquired for all azimuths to be able to remove all “tubing modes” that are common for all directions. Time filtering may comprise eliminating the noise and any other unwanted frequency components. F-K filtering may comprise filtering the signal waves in the frequency-wavenumber domain to get rid of any other acoustic mode that is not of interest. Time windowing may comprise applying a time window to the signal wave received at each receiver 104 (e.g., referring to FIG. 2). The position and length of each time window is calculated taking into account the position of receiver 104 and the acoustic mode of interest. The action performed on the array waveform may create an enhanced data set for the array waveform to form an enhanced array waveform. As noted above, guided wave mode enhancing action may not be utilized on the array waveform. Thus, the array waveform from block 1106 or the enhanced array waveform from block 1108 may be further refined utilizing a beamforming algorithm.

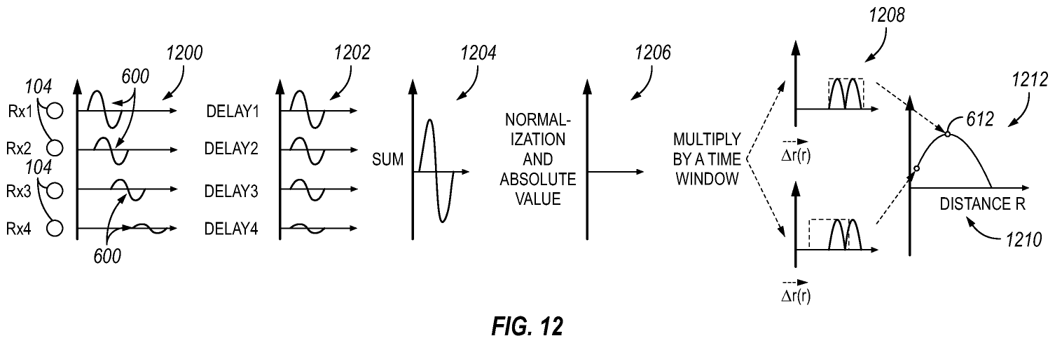

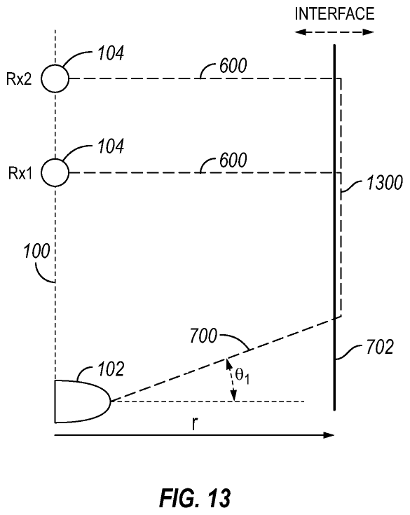

In block 1110 a beamforming action may be performed on the array waveform from block 1106 or the enhanced array waveform from block 1108. The beamforming action may be an algorithm such as a delay-and-sum, Minimum Variance Distortionless Response (MVDR), Maximum Signal-to-Noise Ratio Filter, or any other algorithm. The operation of the delay-and-sum algorithm is illustrated in FIG. 12. In FIG. 12, one or more receivers 104 (e.g., referring to FIG. 1) sense and measure a signal wave 600. As illustrated in graphs 1200, each of the one or more receivers 104 may measure and sense the same signal wave 600 differently. FIG. 13 illustrates as to why signal wave 600 is measured and sensed differently at each of the one or more receivers 104.

FIG. 13 illustrates a measurement operation utilizing acoustic logging tool 100. Specifically, a measurement operation using guided wave ray tracing. During measurement operations, acoustic logging tool 100 may emit an acoustic pulse 700 from transmitter 102. Acoustic pulse 700 may expand as it moves away from transmitter 102 toward interface 702. Further, acoustic pulse 700 may interact with interface 702, which may cause an S-wave 1300 to traverse through interface 702. S-wave 1300 may be recorded as a signal wave 600 that is transmitted perpendicular to S-wave 1300. As illustrated, each of the one or more receivers 104 may measure and sense signal wave 600 at a ninety-degree angle to interface 702.

Referring back to FIG. 12, as illustrated in graph 1202, the amplitude and phase of signal wave 600 measured by each of the one or more receivers 104 may be corrected as a function of the slowness of chosen mode in block 1112 (e.g., referring to FIG. 11) in a mode selection action. Then, each of the measured and sensed signal waves 600 may be summed to find an obtained signal in graph 1204 and normalized in graph 1206. In examples, normalization may be achieved by dividing the obtained signal by the number receivers 104 within the receiver array. In graph 1208, the obtained signal is multiplied by a time window shifted proportionally to the argument r, representing the distance traveled by the sound waves between interface 702 and acoustic logging tool 100 (e.g., referring to FIG. 13). The time window is chosen from block 1114 (e.g., referring to FIG. 11). In block 1114, in a shift time window action the time window is chosen based at least in part on block 1116 (e.g., referring to FIG. 11). In block 1116 a wave path identification action may be performed in which a wave path identification is found utilizing wellbore geometry and acoustic logging tool geometry. This may allow for the time window to be chosen to capture when signal wave 600 is received by at least one receiver 104 during operations. By choosing the time window, noise and/or other interference may be removed, which may prevent processing errors. A peak value 612 in graph 1210 of filtered signal 1212 or its Root Mean Square (RMS) value are the measured values at a first azimuth location for the argument r.

Referring back to FIG. 11, filtered signal 1212, which is the output of block 1110, may be stored for further processing in information handling system 144 (e.g., referring to FIG. 1), using the methods and systems described above. In block 1118, after the argument r is swept three hundred and sixty degrees across casing 108 (e.g., referring to FIG. 1), as acoustic logging tool 100 is rotated within wellbore 110 (e.g., referring to FIG. 1), the proceeding blocks 1104-1116 may be repeated for a new azimuth until acoustic logging tool 100 completes a 360 degrees rotation in block 1120. Then acoustic logging tool 100 may be moved to the next depth and repeat the previous step. For well imaging, the argument r is found where the beamforming output is a local maximum for all azimuths. The measurements taken and found in workflow 1100 may be utilized to determine eccentering in block 1122 in an eccentering estimation action and cement bond evaluation in block 1124 may be performed in a cement bond evaluation action. For example, in block 1122, the eccentric tubing, the distance r calculated, will not be the same as the actual geometric distance between acoustic logging tool 100 and inner casing wall 800, r′ (e.g., referring to FIG. 8), due to the obliquus incidence of acoustic wave 600 at inner casing wall 800. The r to r′ conversion is obtained using a ray-tracing model in FIG. 9.

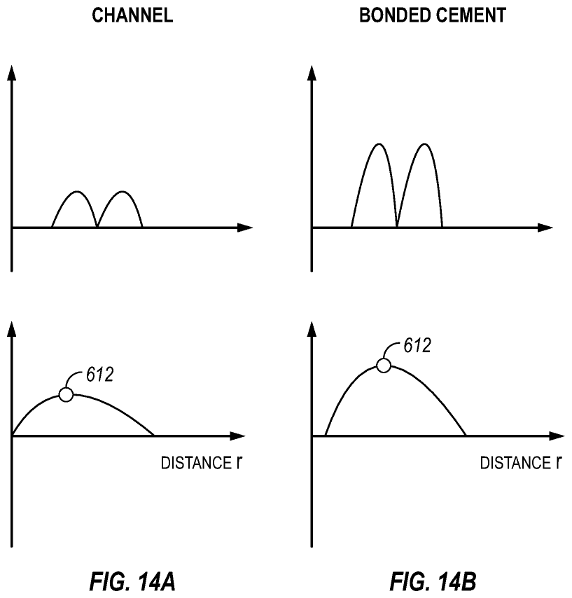

In block 1124 a cement bond evaluation may be performed. For the cement bond evaluation in block 1124, the amplitude obtained when the argument r is equal to the distance traveled between acoustic logging tool 100 and inner casing wall 800 (e.g., referring to FIG. 8), for all azimuths and all measured depths may be compared. For example, as illustrated in FIG. 14A, peak value 612 for distance r indicates a channel may be located behind interface 702, which is inner casing wall 800. In FIG. 14B, the peak value 612 for distance r indicates a full bond between cement and interface 702. Thus, a full three-hundred-and-sixty-degree image may be formed, showing the locations of bonding, channels, and/or partial bonding. Other workflows may be utilized to determine bonding conditions between cement and interface 702.

Due to the presence of the tubing, the signal of interest will be very weak, making the cement bond evaluation and the borehole mapping using the current techniques impossible. The methods and systems described above overcome these issues by using specific beamforming implementation coupled with processing techniques. For example, beamforming may be very flexible when choosing the proper acoustic mode to analyze, making it suitable for applications in different scenarios. The systems and methods described increases measurement sensitivity of acoustic logging tools to the cement behind the casing, which contributes to more reliable evaluations.

Currently, determining a cement bond between casing and cement currently requires tubing to be removed from the wellbore, leaving the casing exposed. At which time an acoustic logging tool or other tool may be disposed within the casing to directly measure cement bond. The methods and systems described above are an improvement over current technology in that they allow for the cement bond to be evaluated without removing the tubing from the wellbore.

Statement 1: A method for identifying a cement bond. The method may comprise disposing an acoustic logging tool into a tubing of a wellbore, wherein the wellbore further comprises casing cemented to a formation by a cement. The method may further comprise transmitting an acoustic signal into at least part of the tubing and at least part of the casing, measuring one or more signal waves from the at least part of the tubing and the at least part of the casing, and computing an array waveform from the one or more signal waves. Additionally, the method may comprise applying a beamforming algorithm to the array waveform to form a filtered signal, identifying eccentricity of the tubing within the casing using the filtered signal, and identifying a cement bond between the cement and the casing.

Statement 2: The method of statement 1, further comprising applying a third interface echo (TIE) enhancement action to the array waveform.

Statement 3: The method of statement 2, wherein the TIE enhancement action comprises a baseline removal, a time filtering, a F-K filtering, a time windowing, or a receiver selection.

Statement 4: The method of statements 1 or 2, wherein the beamforming algorithm is a delay-and-sum algorithm.

Statement 5: The method of statement 4, further comprising applying a time window to the array waveform to shift the array waveform.

Statement 6: The method of any previous statements 1, 2, or 4, wherein the measuring the one or more signal waves is performed by a TIE ray tracing.

Statement 7: The method of any previous statements 1, 2, 4, or 6, wherein the measuring the one or more signal waves is performed by a guided wave ray tracing.

Statement 8: The method of any previous statements 1, 2, 4, 6, or 7, further comprising applying a guided wave mode enhancing action to the array waveform.

Statement 9: The method of statement 8, wherein the guided wave mode enhancing action comprises a baseline removal, a time filtering, a F-K filtering, a time windowing, or a receiver selection.

Statement 10: The method of any previous statements 1, 2, 4, or 6-8, wherein a peak value is identified on the filtered signal to determine the cement bond.

Statement 11: A system may comprise an acoustic logging tool. The acoustic logging tool may comprise at least one transmitter that transmits an acoustic signal into at least part of a tubing and at least part of a casing that the acoustic logging tool may be disposed and at least one receiver that measures one or more signal waves from the at least part of the tubing and the at least part of the casing. The system may further comprise an information handling system that is communicatively connected to the acoustic logging tool and configured to compute an array waveform from the one or more signal waves, apply a beamforming algorithm to the array waveform to form a filtered signal, identify eccentricity of the tubing within the at least part of the casing using the filtered signal, and identify a cement bond between a cement and the at least part of the casing in a wellbore.

Statement 12: The system of statement 11, wherein the information handling system is further configured to apply a TIE enhancement action to the array waveform.

Statement 13: The system of statement 12, wherein the TIE enhancement action comprises a baseline removal, a time filtering, a F-K filtering, a time windowing, or a receiver selection.

Statement 14: The system of any previous statements 11 or 12, wherein the beamforming algorithm is a delay-and-sum algorithm.

Statement 15: The system of statement 14, wherein the information handling system is further configured to apply a time window to the array waveform to shift the array waveform.

Statement 16: The system of any previous statements 11, 12, or 14, wherein the measuring the one or more signal waves is performed by a TIE ray tracing.

Statement 17: The system of any previous statements 11, 12, 14, or 16, wherein the measuring the one or more signal waves is performed by a guided wave ray tracing.

Statement 18: The system of any previous statements 11, 12, 14, 16, or 17, wherein the information handling system is further configured to apply a guided wave mode enhancing action to the array waveform.

Statement 19: The system of any previous statements 11, 12, 14, or 16-18, wherein the guided wave mode enhancing action comprises a baseline removal, a time filtering, a F-K filtering, a time windowing, or a receiver selection.

Statement 20: The system of any previous statements 11, 12, 14, or 16-19, wherein a peak value is identified on the filtered signal to determine the cement bond.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

1. A method comprising:
disposing an acoustic logging tool into a tubing of a wellbore, wherein the wellbore further comprises casing cemented to a formation by a cement;
transmitting an acoustic signal into at least part of the tubing and at least part of the casing;
measuring one or more signal waves from the at least part of the tubing and the at least part of the casing;
computing an array waveform from the one or more signal waves;
applying a beamforming algorithm to the array waveform to form a filtered signal;
identifying eccentricity of the tubing within the casing using the filtered signal; and
identifying a cement bond between the cement and the casing.

2. The method of claim 1, further comprising applying a third interface echo (TIE) enhancement action to the array waveform.

3. The method of claim 2, wherein the TIE enhancement action comprises a baseline removal, a time filtering, a F-K filtering, a time windowing, or a receiver selection.

4. The method of claim 1, wherein the beamforming algorithm is a delay-and-sum algorithm.

5. The method of claim 4, further comprising applying a time window to the array waveform to shift the array waveform.

6. The method of claim 1, wherein the measuring the one or more signal waves is performed by a TIE ray tracing.

7. The method of claim 1, wherein the measuring the one or more signal waves is performed by a guided wave ray tracing.

8. The method of claim 1, further comprising applying a guided wave mode enhancing action to the array waveform.

9. The method of claim 8, wherein the guided wave mode enhancing action comprises a baseline removal, a time filtering, a F-K filtering, a time windowing, or a receiver selection.

10. The method of claim 1, wherein a peak value is identified on the filtered signal to determine the cement bond.

11. A system comprising:
acoustic logging tool comprising:
at least one transmitter that transmits an acoustic signal into at least part of a tubing and at least part of a casing that the acoustic logging tool may be disposed; and
at least one receiver that measures one or more signal waves from the at least part of the tubing and the at least part of the casing; and
an information handling system that is communicatively connected to the acoustic logging tool and configured to:
compute an array waveform from the one or more signal waves;
apply a beamforming algorithm to the array waveform to form a filtered signal;
identify eccentricity of the tubing within the at least part of the casing using the filtered signal; and
identify a cement bond between a cement and the at least part of the casing in a wellbore.

12. The system of claim 11, wherein the information handling system is further configured to apply a TIE enhancement action to the array waveform.

13. The system of claim 12, wherein the TIE enhancement action comprises a baseline removal, a time filtering, a F-K filtering, a time windowing, or a receiver selection.

14. The system of claim 11, wherein the beamforming algorithm is a delay-and-sum algorithm.

15. The system of claim 14, wherein the information handling system is further configured to apply a time window to the array waveform to shift the array waveform.

16. The system of claim 11, wherein the measuring the one or more signal waves is performed by a TIE ray tracing.

17. The system of claim 11, wherein the measuring the one or more signal waves is performed by a guided wave ray tracing.

18. The system of claim 11, wherein the information handling system is further configured to apply a guided wave mode enhancing action to the array waveform.

19. The system of claim 18, wherein the guided wave mode enhancing action comprises a baseline removal, a time filtering, a F-K filtering, a time windowing, or a receiver selection.

20. The system of claim 11, wherein a peak value is identified on the filtered signal to determine the cement bond.
